(19) United States
(12) Patent Application Publication
(10) Pub. No.: US 2003/0126614 A1
(43) Pub. Date: Jul. 3, 2003

(54) Hybrid fiber optic and coaxial cable network node that contains a cable modem termination system

(76) Inventor: Jay G. Staiger, Manlius, NY (US)

Correspondence Address: Philips Electronics North America Corp., 580 White Plains Road, Tarrytown, NY, 10591-5190, US

(21) Appl. No.: 10/029,810

(22) Filed: Dec. 27, 2001

(51) Int. Cl. H04N 7/173

(52) U.S. Cl. 725/111; 725/129; 725/119

(57) ABSTRACT

The present invention provides a system and method for improving the performance of a data communication system, particularly a CATV system, by dividing the functionality of the cable modem termination systems (CMTSs) into functional units, and distributing these functional units among fiber nodes or other locations throughout the data communication system. This approach provides passive return signal paths and their associated benefits.

### BACKGROUND OF THE INVENTION

1. Technical Field

The present invention relates to data communication systems, and more particularly to high speed broadband data communication delivered via multi-channel shared cable television (CATV) systems.

2. Related Art

Data communication systems, such as cable television systems, are well known. A typical cable television (CATV) systems is comprised of a physical entity at a central location known as a headend, with one or more trunk lines extending therefrom. Each trunk line has a plurality of feeder lines extending therefrom into subscriber areas, where each subscriber is attached via a line tap onto the feeder or service line. If the distances between the headend and subscriber areas are substantial, intervening distribution hubs may be located along the trunk lines to replenish the strength and quality of the signal being provided to subscribers.

The trunk, feeder and service lines of many existing CATV systems are all coaxial cables. Since the signals carried by these coaxial cables are electrical, these systems are susceptible to electrical and magnetic noise from natural phenomenon as well as other electrical and magnetic sources. In order to improve the clarity of the signals carried over a CATV system, the coaxial cables used for trunk and feeder lines are being replaced by fiber optic cables. Fiber optic cables carry light signals which are inherently less susceptible to electrical and electromagnetic noise from external sources. In addition, fiber optic cables carry signals for longer distances without appreciable signal strength loss than coaxial cable. However, the cost of replacing existing coaxial cables with fiber optic cables prevents many companies from converting their service lines to fiber optic cables. CATV systems having both fiber optic trunk and feeder lines along with coaxial service lines are typically called hybrid fiber cable (HFC) systems. In HFC systems, the service sites where the light signal from a fiber optic cable is converted to an electrical signal for a coaxial service line is called a fiber conversion node, fiber node, or simply a node.

The utilization of high speed data services over all-coaxial or HFC systems has recently included implementation of headend controllers known as Cable Modem Termination Systems (CMTSs). A CMTS standard is defined in the Data Over Cable Service Interface Specification (DOCSIS) published by Cable Television Laboratories (incorporated herein by reference). A CMTS is described in this document as being normally embodied as a physical entity at a central location, e.g., the system's headend. However, widespread use of this system architecture has produced unforeseen and challenging system engineering issues when new services are deployed within HFC systems. For example, having the entire functionality of the CMTS at the one headend location means that passive return paths are not possible with these existing systems.

### SUMMARY OF THE INVENTION

In a CATV system, passive return paths are desirable because they provide the inherent benefits of, inter alia, reduced cost of return path hardware, since return path amplifiers are not required; return path loss improvements; increased system reliability; increased return path capacity; improved noise funneling; decreased cost of return path optical transmitters; and the capability of carrying forward and return signals on a single fiber optic cable.

The present invention provides a system and method for improving the performance of a HFC CATV system by dividing the functionality of the CMTSs and distributing this functionality throughout the network. This approach provides passive return paths and their associated benefits. The present invention splits the CMTS functionality so that a certain CTMS functionality is locate at the system's headend, and the remaining functionality is distributed around the HFC CATV system and is contained in the optical/electrical conversion, or fiber, nodes.

In a first general aspect, the present invention provides a data communication system comprising: a headend for generating a transmission signal; a plurality of distribution hubs operationally coupled to said headend; a plurality of fiber nodes, each of said fiber nodes being operationally coupled to said distribution hub by a transmission cable and a return cable, said transmission cable coupled to each fiber node providing said transmission signal to said fiber node; a plurality of service lines extending from each of said fiber nodes to operationally couple a plurality of subscriber sites to each of said fiber nodes, and to provide said transmission signal received from said headend at each of said fiber nodes to said subscriber sites; and a plurality of cable modem termination packages operationally coupled to one of said plurality of distribution hubs, one of said plurality of fiber nodes, or one of said plurality of service lines, said cable modem termination packages located downstream from said headend.

In a second general aspect, the present invention a method of employing a data communication system, said method comprising: generating a transmission signal at a headend; operationally coupling a plurality of distribution hubs to said headend; operationally coupling a plurality of fiber nodes to said distribution hub by a transmission cable and a return cable, said transmission cable coupled to each fiber node providing said transmission signal to said fiber node; providing a plurality of service lines extending from each of said fiber nodes to operationally couple a plurality of subscriber sites to each of said fiber nodes, and providing said transmission signal received from said headend at each of said fiber nodes to said subscriber sites; and operationally coupling a plurality of cable modem termination packages to said data communications system, said cable modem termination packages located downstream from said headend.

In a third general aspect, the present invention provides a cable modem termination package comprising: a demodulator circuit; a multiplexor circuit; a demultiplexor circuit; at least one optical transmitter; and at least one optical receiver.

### BRIEF DESCRIPTION OF THE DRAWINGS

The exemplary embodiments of this invention will be described in detail, with reference to the accompanying figures, wherein like designations denote like elements, and wherein:

FIG. 1 is a diagram illustrating an exemplary embodiment of a data communication system of the present invention;

FIG. 2 is a diagram illustrating an exemplary embodiment of a fiber node of the present invention;

FIG. 3 is a diagram illustrating a CMTP of an exemplary embodiment of the present invention; and

FIG. 4 is a diagram illustrating a flow diagram of the signal processing steps occurring in a CMTP in an exemplary embodiment of the present invention.

### DESCRIPTION OF THE EMBODIMENTS

The following is a detailed explanation of the method and system for a data communication system which utilizes Cable Modem Termination Systems (CMTSs), and which provides for passive return paths. The inventive data communication system of the present invention divides the functionality of the CMTS into functional units, hereinafter known as Cable Modem Termination Packages (CMTPs), and distributes the CMTPs to various points within the overall data communication system.

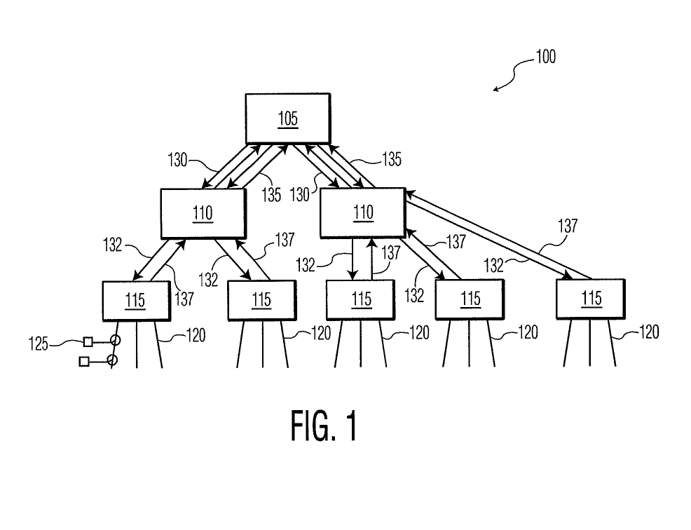

Referring to FIG. 1, a diagram of a data communication system according to the present invention is shown. Data communication system 100 comprises a headend 105, a plurality of distribution hubs 110 coupled to the headend 105, and a plurality of fiber nodes 115 coupled to the distribution hubs 110. Each fiber node 115 is coupled to one or more service lines 120 to which a plurality of service subscribers are coupled through subscriber taps 125. Coupling each fiber node 115 to a corresponding distribution hub 110 is a transmission cable 132 and a receive cable 137. These transmission cables 132, 137 are typically fiber optic cables, while service lines 120 are typically coaxial cables. The optical transmission system 100 of the present invention may employ either Wavelength Division Multiplexing (WDM) or Dense Wavelength Division Multiplexing (DWDM), or both technologies.

The term “fiber node” is commonly used to describe a service site or similar component wherein signals carried by fiber optic cables from a higher level are converted to electrical signals (e.g., RF signals) for transmission along coaxial cables. Each fiber node 115 connected to a distribution hub 110 has its own transmission cable 132 and receive cable 137 to couple the fiber node 115 to the distribution hub 110. Headend 105 is similarly coupled to each distribution hub 110 by transmission cables 130 and receive cables 135.

Referring to FIG. 2, each fiber node 115 commonly includes one or more optical converters 240, wherein the electrical signals received on coaxial cables 120 are converted into optical signals for transmission to a distribution hub 110 along upstream fiber optic cables 137. Similarly, optical signals received via upstream fiber optic cable 132 are processed by additional optical converters 245 into electrical signals for transmission along coaxial cables 120. The optical signals are also processed as necessary with optical multiplexor 260 and an optical demultiplexor 265.

Fiber node 115 may also include a wavelength stabilized source 250, an oscillator 255, an optical multiplexor 260, and an optical demultiplexor 265. The wavelength stabilized source 250 is useful for providing additional processing of the wavelengths of the optical signals before the signals are transmitted on the upstream fiber optic cable 137. The oscillator 255 is also used to process signals for transmission on the fiber optic cables.

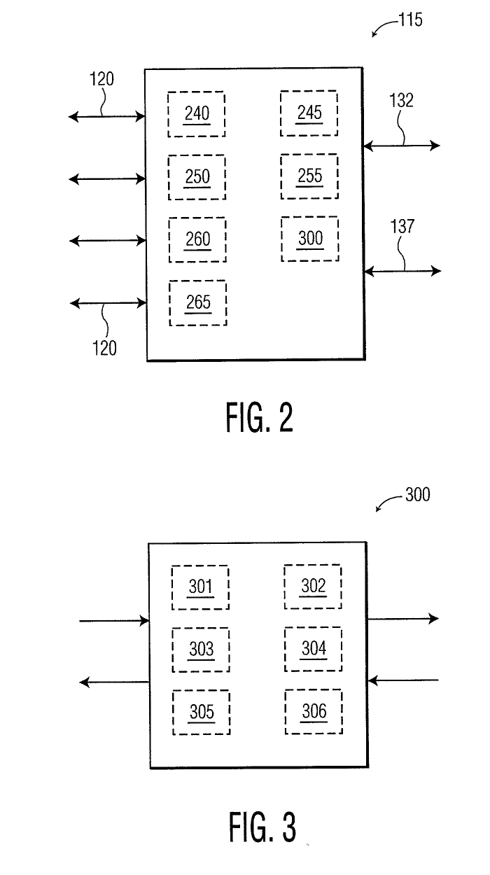

According to the present invention, each fiber node 115 also contains a cable modem termination package (CMTP) 300, as shown in detail in FIG. 3. The CMTP may include, inter alia, electronic devices, optical devices, microprocessors, and related operational software. For instance, use of optical devices such as, inter alia, optical transmitters is desirable since the optical transmitters of digital signals need not have linear performance characteristics. Therefore a significantly lower cost optical transmitter can be used. The CMTP also includes a demodulator circuit 301, a multiplexor circuit 302, a demultiplexor circuit 303, at least one optical transmitter 304, at least one optical receiver 305, and connection devices 306 for operationally connecting said cable termination package to a data communication package.

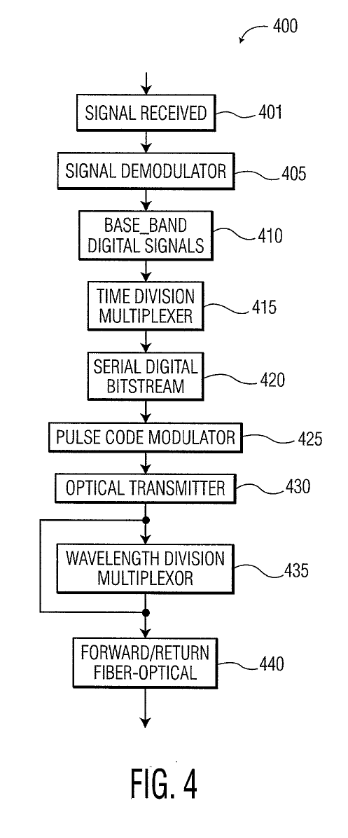

Referring now to FIG. 4, a flow diagram 400 of the signal processing steps occurring in a CMTP is illustrated. Data signals, from each of the return paths 120 (see FIG. 2), are received at an optical receiver in an initial step 401. These signals are processed in a signal demodulator step 405 so that their frequencies are demodulated to their baseband digital signals. These baseband digital signals 410 are then processed by a time division multiplexor circuit 415 to form one serial digital bit stream 420. The serial digital bit stream 420 is processed in a pulse code modulator circuit 425, and is then fed to an optical transmitter 430 on a different signal wavelength than that of the signal wavelength being carried by the fiber optic cable 440. Alternatively, a wavelength division multiplexer circuit 435 can be employed to mix the return optical signal for transmission on the same fiber optic cable as that which carries the forward signals.

The embodiment of the present invention as described herein makes possible a passive return path, since the input signal level required by the presence of the CMTP 300 in the fiber node 115 is lower (e.g., 20 to 30 dB lower) than that required for a fiber node not having the CMTS functions embodied in a CMTP in that node. A derivative feature of this decreased input signal level is that the quantity of signal amplifiers in the return path may be reduced, or the signal amplifiers may be eliminated entirely. A second derivative feature of this feature is that the reduction in, or lack of, return path signal amplifiers results in lower equipment costs for the overall data communication system. Similarly, hardware maintenance expenses are reduced due to the decreased amount of hardware. The decreased amount of hardware also yields increased system reliability, since each piece of hardware that is removed also removes a potential point of failure.

Another improvement provided by the present invention relates to an increase in the signal carrying capacity of the return path. Known HFC fiber nodes typically have four return path inputs that are combined into a single signal for transmission upstream towards the headend. In such a case, the frequency of the return signals from each of the four individual return paths cannot be duplicated. However, the present invention allows the utilization of the frequencies on each of the return paths. Therefore, if there are, for example, four return paths to a particular fiber node, this invention provides an increase of four times the signal carrying capacity for transmitting data signals back upstream towards the headend.

Another benefit resulting from the above feature is related to external noise (e.g., thermal noise and ingress noise). In the related art, when four return paths are combined into a single return path, the noise level is additive. This represents the phenomenon known as noise funneling. In noise funneling, therefore, the noise worsens by a factor of four. In the present invention, each return path is kept separate, so that noise funneling cannot occur.

An additional feature of the present invention is directed towards making larger node serving areas practical. Without the inventive concept of the present invention, the node serving areas are limited because of the noise accumulation effects (i.e., noise funneling) and the limited return path carrying capacity. Since the present inventive concept reduces the noise accumulation by a factor of four, and simultaneously increases the traffic capacity by a factor of four, it follows that the node serving area may be increased by four times.

Although certain exemplary embodiments of the present invention have been shown and described in detail, it should be understood that various changes and modifications may be made without departing from the scope of the present invention. The scope of the present invention will in no way be limited to the number of constituting components, the materials thereof, the shapes thereof, the relative arrangement thereof, etc., and are disclosed simply as an example of the exemplary embodiments.

What is claimed is:

1. A data communication system comprising:
a headend for generating a transmission signal;
a plurality of distribution hubs operationally coupled to said headend;
a plurality of fiber nodes, each of said fiber nodes being operationally coupled to said distribution hub by a transmission cable and a return cable, said transmission cable coupled to each fiber node providing said transmission signal to said fiber node;
a plurality of service lines extending from each of said fiber nodes to operationally couple a plurality of subscriber sites to each of said fiber nodes, and to provide said transmission signal received from said headend at each of said fiber nodes to said subscriber sites; and
a plurality of cable modem termination packages operationally coupled to one of said plurality of distribution hubs, one of said plurality of fiber nodes, or one of said plurality of service lines, said cable modem termination packages located downstream from said headend.

2. The system of claim 1, wherein said transmission signal includes a cable television (CATV) signal.

3. The system of claim 1, wherein said cable modem termination packages are located at said distribution hubs.

4. The system of claim 1, wherein said cable modem termination packages are located at said fiber nodes.

5. The system of claim 1, wherein said cable modem termination packages are located at said subscriber sites.

6. The system of claim 1, wherein said fiber nodes further include:
an upstream connection operationally connected, by a plurality of first data carrying cables, to a first distribution point; and
a downstream connection operationally connected by a plurality of second data carrying cables, to a second distribution point.

7. The system of claim 6, wherein said plurality of first data carrying cables are fiber optic cables.

8. The system of claim 6, wherein said plurality of second data carrying cables are fiber optic cables.

9. The system of claim 6, wherein said plurality of second data carrying cables are co-axial cables.

10. The system of claim 6, wherein said first distribution point is a distribution hub.

11. The system of claim 6, wherein said first distribution point is a fiber node.

12. The system of claim 6, wherein said second distribution point is a fiber node.

13. The system of claim 6, wherein said second distribution point is a subscriber site.

14. The system of claim 6, wherein said first distribution point is a distribution hub.

15. A method of employing a data communication system, said method comprising:
generating a transmission signal at a headend;
operationally coupling a plurality of distribution hubs to said headend;
operationally coupling a plurality of fiber nodes to said distribution hub by a transmission cable and a return cable, said transmission cable coupled to each fiber node providing said transmission signal to said fiber node;
providing a plurality of service lines extending from each of said fiber nodes to operationally couple a plurality of subscriber sites to each of said fiber nodes, and providing said transmission signal received from said headend at each of said fiber nodes to said subscriber sites; and
operationally coupling a plurality of cable modem termination packages to said data communications system, said cable modem termination packages located downstream from said headend.

16. The method of claim 15, wherein said step of generating a transmission signal includes generating a cable television (CATV) signal.

17. The method of claim 15, wherein said step of coupling said cable modem termination packages includes locating said cable modem termination packages at said distribution hubs.

18. The method of claim 15, wherein said step of coupling said cable modem termination packages includes locating said cable modem termination packages at said fiber nodes.

19. The method of claim 15, wherein said step of coupling said cable modem termination packages includes locating said cable modem termination packages at said subscriber sites.

20. The method of claim 15, wherein said step of operationally coupling a plurality of fiber nodes to said distribution hub further includes:
operationally connecting an upstream connection of said fiber node, with a plurality of first data carrying cables, to a first distribution point; and
operationally connecting a downstream connection of said fiber node with a plurality of second data carrying cables, to a second distribution point.

21. The method of claim 20, wherein said plurality of first data carrying cables are fiber optic cables.

22. The method of claim 20, wherein said plurality of second data carrying cables are fiber optic cables.

23. The method of claim 20, wherein said plurality of second data carrying cables are co-axial cables.

24. The method of claim 20, wherein said first distribution point is a distribution hub.

25. The method of claim 20, wherein said first distribution point is a fiber node.

26. The method of claim 20, wherein said second distribution point is a fiber node.

27. The method of claim 20, wherein said second distribution point is a subscriber site.

28. The method of claim 20, wherein said first distribution point is a distribution hub.

29. A cable modem termination package comprising:
a demodulator circuit;
a multiplexor circuit;
a demultiplexor circuit;
at least one optical transmitter; and
at least one optical receiver.

30. The cable modem termination package of claim 29, further comprising connection devices for operationally connecting said cable termination package to a data communication system.

31. The package of claim 30, wherein said connection devices include coaxial cable connection devices.

32. The package of claim 30, wherein said connection devices include fiber optic cable connection devices.

33. The package of claim 29, wherein said multiplexor circuit is a time division multiplexor circuit.

34. The package of claim 29, wherein said multiplexor circuit is a wavelength division multiplexor circuit.

35. The package of claim 29, wherein said demultiplexor circuit is a time division demultiplexor circuit.

36. The package of claim 29, wherein said demultiplexor circuit is a wavelength division demultiplexor circuit.
